(19) United States
(12) Patent Application Publication
(10) Pub. No.: US 2010/0249678 A1
(43) Pub. Date: Sep. 30, 2010

(54) Zeleny therapeutic sonosphere

(76) Inventor: Charles Timberlake Zeleny, Baltimore, MD (US)

Correspondence Address: DUANE MORRIS LLP - DC, 505 9th Street, Suite 1000, WASHINGTON, DC, 20004-2166, US

(21) Appl. No.: 12/662,022

(22) Filed: Mar. 29, 2010

Related U.S. Application Data
(63) Continuation-in-part of application No. 12/292,948, filed on Dec. 1, 2008.
Application No. 12/292,948 is a continuation-in-part of application No. 12/292,949, filed on Dec. 1, 2008.

(51) Int. Cl. A61H 1/00

(52) U.S. Cl. 601/47

(57) ABSTRACT

An apparatus for treating a human body with waves, comprising: (i) an inverse wave generating system comprising a substantially rigid, water-tight shell defining a substantially spherical cavity and having a plurality of individual wave generating elements located at predetermined locations on the inner surface thereof and a diameter sufficient to accommodate at least one human body without it contacting the inner surface of the shell or the individual wave generating elements; and (ii) an external frame for positioning the inverse wave generating system relative to the external environment. These apparatus are useful for applying waves to a human body for therapy.

### CROSS-REFERENCE TO RELATED APPLICATIONS

This application is a continuation-in-part of U.S. patent application Ser. No. 12/292,948, filed Dec. 1, 2008, U.S. patent application Ser. No. 12/292,949, filed Dec. 1, 2008, the entirety of each of which is expressly incorporated herein by reference.

### FIELD OF THE INVENTION

The present invention relates to an apparatus for applying directional waves to a human body, including energy waves that affect one or more biological contaminants within that human body and signal waves that elicit an effect from a receiver located within that human body.

### BACKGROUND OF THE INVENTION

There are presently a number of methods and techniques for the treatment of cancer, among which may be included: radiation therapy, chemotherapy, immunotherapy, and surgery. The common characteristic for all of these techniques, as well as the vast majority of other currently known techniques, is that they are extracellular in scope, i.e. the cancer cell is attacked and attempted to be killed through application of a killing force or medium outside of the cell.

Similarly approaches have been taken with respect to other potential biological contaminants that affect humans, such as viruses and bacteria. That is, to date, the vast majority of therapeutic techniques have focused on attacking and destroying the biological contaminant through application of some external agent, such as an antibiotic or antiviral drug.

The extracellular approach is found to be less effective because of the difficulties of penetrating the biological contaminant. For example, a cancer cell is surrounded by a membrane composed of two protein layers with a lipid layer in between. Bacteria are similarly surrounded by a cell membrane, which, in turn, is surrounded by a peptidoglycan cell wall. Viruses are surrounded by a capsid, a tough protein shell.

Of even greater significance when using an extracellular approach is that in order to overcome the protection afforded the cell membrane/cell wall/capsid, the attack must be of such intensity that considerable damage is frequently caused to the normal cells, which in turn causes potentially severe side effects in the patient. These side effects have frequently been found to limit the effectiveness and usefulness of extracellular treatment of biological contaminants in a human body.

Safe and effective treatments of biological contaminants have been the goal of many researchers and investigators for a substantial period of time. To be successful, such techniques should be completely selective, and permanently affect only the biological contaminant and not the normal cells. In sum, such a treatment must selectively differentiate the biological contaminant from normal cells and must selectively weaken or kill the biological contaminant without concomitant damage to the normal cells.

### SUMMARY OF THE INVENTION

It is therefore an object of the present invention to provide an apparatus that overcomes some or all of the problems associated with known devices and treatments. Other objects, features and advantages of the present invention will be set forth in the detailed description of preferred embodiments that follows, and in part will be apparent from the description or may be learned by practice of the invention. These objects and advantages of the invention will be realized and attained by the apparatus and methods particularly pointed out in the written description and claims hereof.

In accordance with these and other objects, a first embodiment of the present invention is directed to an apparatus for the therapeutic application of waves to a human body. Such an apparatus comprises an inverse wave generating system operably connected to an adjustable external support frame. The inverse wave generating comprises a substantially rigid, water-tight shell defining a substantially spherical cavity having a diameter sufficient to accommodate at least one human body without said body contacting the inner surface thereof and having a plurality of wave generating elements at predetermined locations on the inner surface. The external support frame holds the inverse speaker system in a particular orientation relative to the external environment, particular with respect to one or more external magnetic flux lines. Optionally, the apparatus may also include a motor for changing the position of the inverse wave generating relative to the external environment.

A second embodiment of the present invention is directed to a method of treating a human body to reduce the level of a biological contaminant, such as a virus or a neoplastic cell. This method involves placing a human inside an apparatus as described above and then subjecting that human to energy waves having at least one frequency characteristic of the biological contaminant but not characteristic of normal cells, for a time sufficient to disrupt the biological contaminant.

A third embodiment of the present invention is directed to a method of treating a human body to reduce the level of a biological contaminant, such as a virus or a neoplastic cell. This method involves implanting a plurality of transponders in a human and then placing that human inside an apparatus as described above, followed by subjecting that human to energy waves having at least one frequency characteristic of one or more of the transponder(s) but not characteristic of normal cells, for a time sufficient to elicit a desired response from the transponder(s).

It is to be understood that both the foregoing general description and the following detailed description are exemplary and explanatory only and are intended to provide further explanation of the invention as claimed.

### DESCRIPTION OF THE DRAWINGS

The invention will be more readily understood from a non-limiting description of certain preferred embodiments that follows and from the diagrammatic figure of the drawings.

FIG. 1 shows a schematic diagram of one preferred embodiment of the present invention (The Zeleny Therapeutic Sonosphere CE-302(B)).

### DETAILED DESCRIPTION OF THE PREFERRED EMBODIMENTS

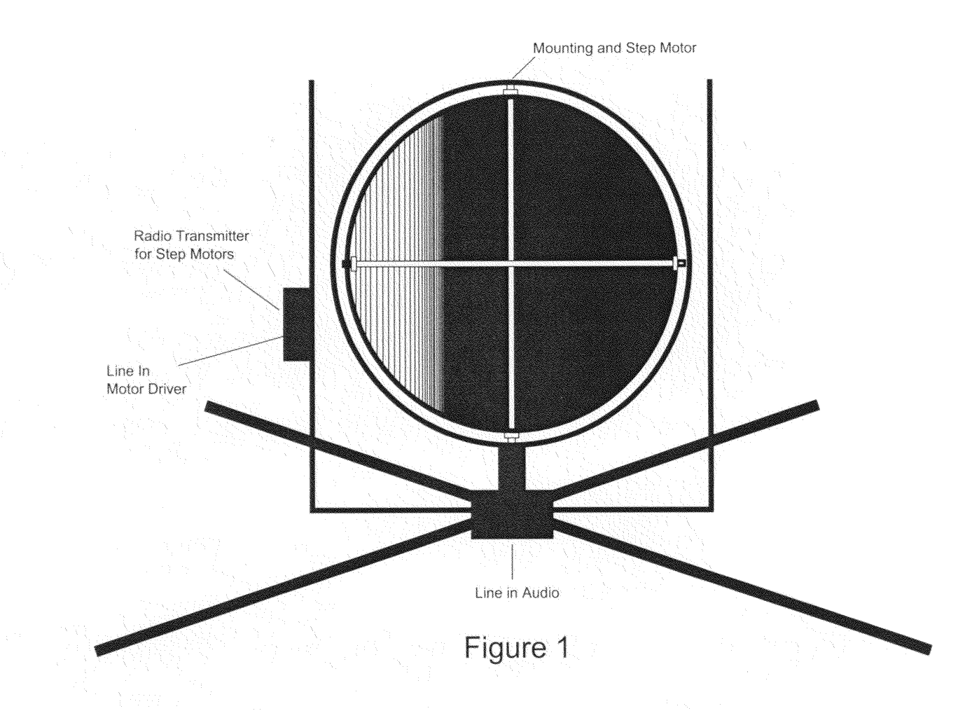

Referring now to FIG. 1, there is shown a schematic diagram for one embodiment of the present invention. As shown in FIG. 1, this preferred embodiment comprises an inverse wave generating system operably connected to an adjustable external support frame. This inverse wave generating system comprises a substantially rigid, water-tight shell defining a substantially spherical cavity. This cavity is large enough to accommodate at least one human body without it touching the inner surface of the shell, including any sound-reproducing elements located thereon. As used herein, the term “water-tight” is intended to mean that the shell will retain at least 95% of any fluid, such as water, placed therein for at least 24 hours.

According to certain preferred embodiments of the present invention, the substantially rigid, water-tight shell is filled with a fluid, such as water or oil, or a mixture of fluids. Preferred fluids are those which will permit the effective transmission of sound waves from one or more sound-reproducing elements to a human located within the cavity defined by the shell. Specific fluid or fluids may be selected empirically by one skilled in the art. According to certain very particularly preferred embodiments, the fluid is primarily water. One skilled in the art may determine the appropriate level of fluid (relative to the top of the substantially spherical shell) empirically, based on factors such as the size of the human contained within the shell and the desired position thereof. Preferably, the shell is substantially filled with fluid, more preferably to at least 90% of its volume, and even more preferably to at least 95% of its volume.

According to certain embodiments of the invention, the diameter of the substantially rigid shell will be sufficient to accommodate a human adult or child lying in a horizontal position and equipped with a suitable breathing apparatus, e.g. a diameter of at least 3 meters. According to other embodiments of the invention, the diameter of the substantially rigid shell will be sufficient to accommodate a human adult in a standing position, e.g. a diameter of at least 3 meters, while according to other embodiments, the diameter will only be sufficient to accommodate a human child in a standing position or a human adult in a sitting position, e.g. a diameter of about 2 meters. According to still other embodiments, the diameter will only be sufficient to accommodate a human infant or a human child in a sitting position, e.g. a diameter of about 1 meter.

According to certain preferred embodiments of the present invention, the wave generating elements located on at least a portion of the interior surface of the substantially spherical shell are sound-reproducing elements. According to other embodiments, particular those described in greater detail below, the wave generating elements may produce electro-magnetic waves, electro-static waves, microwaves, signals actuating one or more in vivo devices, or the like, as desired for a particular application. Suitable devices are known to those skilled in the art.

In the case of sonic transmission, the individual sound-reproducing elements may be any suitable sound-reproducing structure known and available to those skilled in the art. Suitable sound-reproducing structures, and means for connecting and operating the same, are described, for example, in the following: U.S. Pat. No. 3,636,278 to Heil for “Acoustic Transducer with a Diaphragm Forming a Plurality of Adjacent Narrow Airspaces Open Only at One Side with Open Sides of Adjacent Air Spaces Alternatingly Facing in Opposite Directions”; U.S. Pat. No. 4,056,697 to Heil for “Movable Diaphragm Connector Method Flexible Hinge Diaphragm Surround and Electro-Acoustic Transducer with Folded Diaphragm with Intermediate Positions”; U.S. Patent Application Publication No. US 2004/0052386 to Heron for “Panel Form Loudspeaker”; U.S. Patent Application Publication No. 2004/0066938 to Heron for “Loudspeaker”; U.S. Pat. No. 5,473,700 to Fenner for “High Gain Acoustic Transducer”; and U.S. Pat. No. 6,545,948 to Jiang for “Submersible Loudspeaker”. The disclosures of each of these documents is hereby expressly incorporated by reference.

According to certain preferred embodiments of the present invention, the individual sound-reproducing elements may be in the shape of individual strips, each of which comprises a plurality of at least partly vibratory diaphragm portions arranged to define between themselves adjacent narrow airspaces. The strips are connected in such a way that the adjacent airspaces are alternatingly closed and left open at opposite ends. Such strips are preferably long enough to reach from one pole of the inverse speaker system to the other pole. Alternatively, the strips may reach from a pole of the inverse speaker system to just below the mid-point, or equator, of the substantially spherical arrangement. Each strip also includes means for transforming vibrations imparted thereto by electric energy into sound waves through the air or through fluid. The strips are connected to one another in such a manner as not to interfere with the production of sound waves thereby. Suitable connecting means are known in the art.

According to other preferred embodiments of the present invention, the individual sound-reproducing elements may be in the form of pentagonal and hexagonal panels. Such panels may be of any suitable size and dimension, and are preferably arranged in a geometric, “buckyball” fashion. Each of these panels has at least one electro-mechanical drive means coupled thereto to excite a multi-modal resonance in said panel in response to an electrical input within a working frequency band for the inverse speaker system. Each panel is held in place by mounting means, which supports the panel and/or attaches the panel to a supporting body in a free undamped manner. Suitable mounting means are known in the art.

According to still other preferred embodiments of the present invention, the individual sound-reproducing elements are panels in the shape of near hemi-spherical shells, varying from a “perfect” equatorial hemisphere down to 25% of a “perfect” equatorial hemisphere. According to certain very preferred embodiments, the panels form a separate array residing within the water-tight shell. Each of these panels also has at least one electro-mechanical drive means coupled thereto to excite a multi-modal resonance in said panel in response to an electrical input within a working frequency band for the inverse speaker system and each panel is held in place by suitable mounting means. Such mounting means are known to those skilled in the art.

Regardless of the shape selected, the individual sound-reproducing elements must be arranged such that a human can enter and leave the cavity defined by the shell. The same is true for any other wave generating elements. The particulars of such will depend on the specific shape(s) employed and so can be determined empirically by one skilled in the art. For example, if the individual sound-reproducing elements or other wave generating elements are in the shape of individual strips extending from one pole to the other, provision can be made to permit the separation of two strips by a distance sufficient to permit a human to enter the cavity, such as by providing one or more hinges along an outer edge of the shell or by an opening near the top of the shell. Alternatively, if the individual wave generating elements are in the shape of panels, one or more panels may be arranged to be movable to permit a human to enter the cavity of the substantially spherical shell.

The outer shell of the inventive wave generating system is substantially spherical, i.e. points on the surface of the shell will all be substantially the same distance from a fixed point. Preferably, all points on the surface of the inverse speaker system will be within 10% of a predetermined distance from a fixed point within the cavity defined by the shell. More preferably, all points on the surface will be within 5% of a predetermined distance from a fixed point within the shell, and even more preferably within 2%. Still even more preferably, all points on the surface will be within 1% of a predetermined distance from a fixed point within the shell, and most preferably within 0.1%.

The individual wave generating elements are located at predetermined locations on the inner surface of the substantially rigid shell. Suitable locations may be determined empirically by one skilled in the art. According to certain preferred embodiments, the individual wave generating elements are located such that the waves from any two elements will not cancel or otherwise interfere with each other. According to certain preferred embodiments, all of the wave generating elements are located within the same hemisphere of the substantially spherical shell. According to more very preferred embodiments, all of the wave generating elements are located within the same hemisphere of the substantially spherical shell and cover less than all of that hemisphere. According to still even more very preferred embodiments, the wave generating elements comprise a separate array within a single hemisphere of the substantially spherical shell except for a predetermined area adjacent to the equator of the sphere.

According to certain preferred embodiments of those embodiments where a plurality of wave generating elements are located on the same hemisphere of the substantially spherical shell, a plurality of wave canceling and/or wave dampening elements are located at predetermined locations on the interior surface of the opposite hemisphere of the substantially spherical shell. Such wave canceling and/or wave dampening elements may reduce, or perhaps even eliminate, reflection of waves. Suitable wave canceling and/or wave dampening elements are known to those skilled in the art.

According to certain preferred embodiments of the present invention, the inventive inverse wave generating system further comprises substantially rigid support means for supporting a human body within the cavity of the substantially spherical shell. For example, a substantially rigid support means may be in the shape of a chair or stool or platform large enough to support the user. The support means must be of sufficient strength to remain substantially rigid when subjected to the user's weight. Examples of materials that can be used for the support means include, but are not limited to, wood, sound board, plywood, particle board, organic fiber, composite insulation board, plastic, glass, Plexiglas, fiberglass, metal, stone, marble, etc.

According to other preferred embodiments of the present invention, the inventive inverse wave generating system does not contain any substantially rigid support means for supporting a human body within the cavity of the substantially spherical shell. For example, when the shell is substantially filled with a fluid of sufficient viscosity to maintain a human within the cavity without contacting the inner surface of the shell or any wave generating elements, the inventive wave generating system preferably does not contain any substantially rigid support means for supporting that human. According to such embodiments, the patient may be retained in place by other means, so as to prevent flotation or displacement away from the center of the spherical shell. Such other means are known and readily apparent to those skilled in the art, and may include, for example, a plurality of specifically gauged wires attached at predetermined locations on the patient's body to retain the patient in a predetermined location without adversely affecting the transmission of the waves to that patient.

The present invention also preferably includes at least one wave generator having plurality of outputs connected to the individual wave generating elements. According to certain embodiments, the wave generator may be any sort of device that generates an electrical output which may be converted into acoustic vibrations. Examples of some types of sound generators include, but are not limited to, synthesized signal generating modules, in vivo wave generating elements, stereo systems, radio receivers, phonographs, compact disc players, tape recorders and players, cable box decoders, satellite signal capturing devices, televisions, video cassette recorders, Internet connecting devices, etc. The wave generator may also include either an internal or external amplifier.

Controls for the wave generator may be accessible to the user inside the internal cavity or may be controlled by someone outside. Most preferably, each individual wave generating element may be controlled using a separate control. These controls may be either a specifically designed device or a general purpose computer employing a software program to regulate delivery of the frequency vibrations or other waves to the user. This computer may also receive signals broadcast from within a patient's body via telemetry from one or more in vivo implants.

According to certain preferred embodiments, the inverse wave generating system of the present invention emits acoustic vibrations in a range that will adversely affect the biological contaminant in the human patient without concomitant permanent damages to the normal cells of that patient. Suitable frequency ranges will vary depending upon the specific biological contaminant(s) being treated, and can be determined empirically by one skilled in the art. Preferred frequency ranges are those that include at least one resonant frequency uniquely associated with the biological contaminant being treated, and even more preferred frequency ranges include at least one resonant frequency uniquely associated with a critical internal structure or component of the contaminant. For example, if the biological contaminant is a virus, the frequency employed will generally lie in the range of from 1 GHz to 300 GHz, but higher frequencies may also be used.

According to other preferred embodiments, the inverse wave generating system of the present invention emits waves of a frequency that will activate and/or instruct one or more transponders implanted within the human patient without concomitant permanent damages to the normal cells of that patient. Suitable frequencies, or even ranges thereof, will vary depending upon the specific transponders(s) involved and/or result desired, and can be determined empirically by one skilled in the art. Such frequencies preferably cause the implanted transponder(s) to perform some predetermined function(s) within the human patient's body.

For example, one or more of the transponders described in co-pending U.S. patent application Ser. No. 12/654,325 (T2203-00012), filed Dec. 16, 2009, the disclosure of which is expressly incorporated herein in its entirety, may be implanted in a human body, for example subcutaneously or intramuscularly or the like, or introduced into the blood or lymph system or introduced into the gastrointestinal system. Such a transponder may include electrical or non-electrical components adapted to interface or interact with cells of the body and/or other transponders implanted within the same human and/or other external receivers and devices, as appropriate. The wireless capability of the transponder may thus enable the delivery of electrical or non-electrical signals to, for example, cells, peripheral nerve tissue and signals configured to stimulate peripheral nerves distributed throughout subcutaneous tissue of the subject. Similar results may likewise be achieved in other predetermined tissues and/or regions within the human body.

For example, transponder(s) may be implanted surgically at the vegas nerve and impulses employed to correct common hiccups, epilepsy and even major depression. When suitable transponders are surgically implanted at or near nerves associated with a heart's mitral valve region, the apparatus of the present invention may be employed to correct atrial fibrillation and other arrhythmias. When introduced into the bloodstream, suitable transponders may be employed to destroy cells containing biological contaminants and/or genetic defects via the application of suitable waves to those transponders using the apparatus of the present invention.

Also by way of example, the inventive apparatus may be employed in methods of treating or ameliorating disease states, such as cancer, using high intensity focused ultrasound (HIFU). HIFU uses high frequency sound waves delivered in a focused beam to a specific part of the patient's body, such as the site of a tumor. Cells, including cancer cells, die when this high intensity ultrasound beam is focused directly onto them. The apparatus of the present invention may be used as the source of the high intensity ultrasound in such methods.

Referring again to FIG. 1, the inventive apparatus also includes an adjustable external support frame which can position the plurality of individual wave generating elements and/or the outer shell in any desired orientation with respect to the external environment. Optionally, such an apparatus may also include a motor for changing the position of the wave generating elements of the inverse speaker system relative to the internal environment and/or external environment. According to certain particularly preferred embodiments, the external support frame is a gyroscope.

According to certain embodiments, the inventive apparatus also may include means for regulating and/or adjusting the temperature of any fluid contained with the substantially rigid, water-tight shell.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art, including combinations of two or more of the various preferred embodiments described above.

What is claimed is:

1. An apparatus for treating a human body with waves, said apparatus comprising: (i) an inverse speaker system comprising a substantially rigid, water-tight shell defining a substantially spherical cavity, said shell having a plurality of individual wave generating elements located at predetermined locations on the inner surface thereof and having a diameter sufficient to accommodate at least one human body without said body contacting said inner surface of said shell or said individual wave-generating elements; and (ii) an external frame for positioning said inverse wave generating system relative to the external environment.

2. The apparatus according to claim 1, further comprising at least one motor operably connected to said adjustable external support frame for mechanically adjusting the position of said inverse wave generating system in a desired orientation with respect to the external environment.

3. The apparatus according to claim 1, wherein said external support frame comprises a gyroscope.

4. The apparatus according to claim 1, wherein said wave generating elements are sound-reproducing elements.

5. The apparatus according to claim 4, wherein each of said plurality of individual sound-reproducing elements comprises a plurality of closely spaced, partially vibratable diaphragm portions arranged substantially parallel to one another and defining between themselves narrow airspaces; and means connected to each of said vibratable diaphragm portions closing each of said airspaces all around with the exception of one side which remains acoustically open, wherein said open sides of adjacent airspaces face in opposite directions.

6. The apparatus according to claim 4, wherein each of said plurality of individual sound-reproducing elements comprises a panel of suitable dimension and stiffness and at least one electro-mechanical drive means coupled to said panel to excite a multi-modal resonance in said panel in response to an electrical input within a working frequency band for said sound-reproducing element.

7. The apparatus according to claim 5, further comprising mounting means which supports said panel and/or attaches said to a supporting body in a free undamped manner.

8. The apparatus according to claim 1, further comprising means for supporting a human within the internal cavity of said substantially rigid, water-tight shell.

9. The apparatus according to claim 1, wherein said substantially rigid, water-tight shell is substantially filled with at least one fluid.

10. The apparatus according to claim 8, wherein said fluid comprises water.

11. The apparatus according to claim 1, wherein all of said individual wave generating elements are located on one hemisphere of said substantially rigid, water-tight shell.

12. The apparatus according to claim 8, further comprising means for adjusting and/or regulating the temperature of said fluid.

13. A method for reducing the level of a biological contaminant in a human patient, said method comprising:
determining at least one characteristic frequency of said biological contaminant;
determining at least one characteristic frequency of normal cells obtained from said human patient, wherein said at least one characteristic frequency of normal cells is not the same as said at least one characteristic frequency of said biological contaminant;
applying to said human patient high-intensity corrective waves based on said at least one characteristic frequency of said biological contaminant for a time sufficient to reduce the level of said biological contaminant in said human.

14. The method according to claim 12, further comprising the steps of:
determining the alignment of at least one desired magnetic field; and
positioning said human patient in a predetermined arrangement with respect to said alignment prior to said applying step.

15. The method according to claim 12, wherein said biological contaminant comprises at least one active virus.

16. The method according to claim 12, wherein said biological contaminant at least one neoplastic cell.

17. The method according to claim 12, wherein said at least one characteristic frequency of said biological contaminant is in the range of from 1 GHz to 300 GHz.

18. The method according to claim 12, wherein said step of applying corrective waves includes placing said human patient in an apparatus comprising: (i) an inverse wave generating system comprising a substantially rigid, water-tight shell defining a substantially spherical cavity, said shell having a plurality of individual wave generating elements located at predetermined locations on the inner surface thereof and having a diameter sufficient to accommodate at least one human body without said body contacting said inner surface of said shell or said individual wave generating elements; and (ii) an external frame for positioning said inverse speaker system relative to the external environment.

19. A method for reducing the level of a biological contaminant in a human patient, said method comprising:
introducing at least one transponder into said human;
identifying at least one characteristic frequency of said transponder;
determining at least one characteristic frequency of normal cells obtained from said human patient, wherein said at least one characteristic frequency of normal cells is not the same as said at least one characteristic frequency of said transponder;
applying to said human patient waves based on said at least one characteristic frequency of said transponder for a time sufficient to elicit a predetermined effect in said human.
